(19) United States
(12) Patent Application Publication
(10) Pub. No.: US 2022/0402772 A1
(43) Pub. Date: Dec. 22, 2022

(54) NON-REAGENT METHODS AND PROCESS CONTROL FOR MEASURING AND MONITORING HALIDE CONCENTRATIONS IN ELECTRODEPOSITION SOLUTIONS FOR IRON TRIAD METALS AND THEIR ALLOYS

(71) Applicant: ECI TECHNOLOGY, INC., Totowa, NJ (US)

(72) Inventors: Eugene SHALYT, Washington Township, NJ (US); Chuannan BAI, Bridgewater, NJ (US); Vishal PAREKH, Parsippany, NJ (US); Boling DENG, Parsippany, NJ (US)

(73) Assignee: ECI TECHNOLOGY, INC., Totowa, NJ (US)

(21) Appl. No.: 17/742,837

(22) Filed: May 12, 2022

Related U.S. Application Data
(63) Continuation of application No. PCT/US2022/021117, filed on Mar. 21, 2022.
(60) Provisional application No. 63/220,052, filed on Jul. 9, 2021.
(60) Provisional application No. 63/209,128, filed on Jun. 10, 2021.

(51) Int. Cl. C01G 49/00; C01G 51/00; C01G 53/00

(52) U.S. Cl. CPC C01G 49/009; C01G 49/0009; C01G 51/006; C01G 53/006; C01P 2006/60

(57) ABSTRACT

Techniques including methods and apparatuses for selective measurement and monitoring of halide concentrations in processing solutions for iron triad metals and their alloys are provided. Methods include monitoring of a halide ion, for example, based on a first analytical method such as conductivity with a compensation of the results for a main metal concentration such as a second analytical measurement of concentration of an iron triad metal (e.g., nickel (Ni)). From such measurements, a concentration of certain halide ions can be selectively determined.

### CROSS-REFERENCE TO RELATED APPLICATIONS

This application is a continuation of International Patent Application No. PCT/US2022/021117 filed Mar. 21, 2022, which claims priority to U.S. Provisional Patent Application Serial Nos. 63/209,128, filed on Jun. 10, 2021, and 63/220,052, filed on Jul. 9, 2021, the contents of each of which are hereby incorporated by reference in their entirety.

### FIELD

The present disclosure relates to analysis and process control of processing solutions, for example, semiconductor processing solutions, and to techniques for selective measurement and monitoring of halide concentrations in such processing solutions for iron triad metals and their alloys.

### BACKGROUND

Processing solutions are used in several industries, including semiconductor industries, to produce products with desired properties. Such processing solutions can include triad iron metals, such as nickel (Ni) electrodeposits, which are widely used in electronics, semiconductor, automotive or other industries for their suitable characteristics. For example, triad iron metals (e.g., nickel (Ni) electrodeposits) can have magnetic properties which can be changed by varying ratios of different metal ions in the processing solution. Such triad iron metals, such as nickel (Ni) electrodeposits, can further have high chemical resistivity due to a passive layer of nickel oxides, tunable stress levels, and high diffusion layer properties.

For nickel (Ni) electrodeposits, passivation characteristics of nickel (Ni) can reduce or prevent the use of a nickel (Ni)-based anode, for example, in a nickel sulfate (NiSO₄) electrolyte. In order to counteract such passivation characteristics, a halide ion (e.g., chloride (Cl), bromide (Br), or iodide (I)) can be used to depassivate the nickel (Ni) surface in order to enable an anode reaction (e.g., Ni+6Halide (−)→NiHalide6(4-)+2 e(−)). Further, the halide ion can be consumed at the anode due to a side reaction (e.g., 2Halide(−)→Halogen2+2e(−)). Accordingly, halide ions in processing solutions can be monitored and replenished as needed for consistent process performance.

Such measuring and monitoring can be conducted through titration methods, for example, with silver nitrate (AgNO₃). However, such methods can require a reagent, have a relatively long processing time as multiple incremental additions of titrant are needed, be relatively expensive in requiring a titrant including silver (Ag) salt and have safety implications resulting from the toxicity of silver (Ag). For example, safety issues can arise relating to the need to extract samples for analysis and perform waste treatment after analysis. Certain approaches can have disadvantages including potentiometry with specific ion selective electrodes, which requires a further dilution step for high concentrations. Other methodologies such as ion chromatography and capillary electrophoresis can both be relatively expensive, difficult to automate, and have a relatively long analysis time.

### SUMMARY

It is thus desirable to provide processes and apparatuses to provide for economic, safe, efficient, relatively rapid, and accurate selective measurement and monitoring of halide concentrations in processing solutions for iron triad metals and their alloys. The present disclosure addresses these and other needs by providing techniques for selective measurement and monitoring of halide ions (e.g., chloride (Cl), bromide (Br), or iodide (I)) in processing solutions such as semiconductor processing solutions.

An exemplary method for determining a concentration of a halide ion in a processing solution including a plurality of halide ions and one or more plating metals is provided. The method includes performing a first analytical method comprising measuring a conductivity of the processing solution to provide a first measurement, performing a second analytical method to provide a second measurement, and determining a concentration the halide ion based on the first and the second measurements. The halide ion can be selected from the plurality of halide ions. The first analytical method can be different than the second analytical method.

In certain embodiments, the second analytical method can include measuring a concentration of the one or more plating metals.

In certain embodiments, the concentration of the one or more plating metals can be measured by UV-Vis (ultraviolet-visible spectroscopy).

In certain embodiments, the second analytical method can include measuring an absorbance of the processing solution.

In certain embodiments, the plurality of halide ions can include chloride (Cl), bromide (Br), iodide (I), or combinations thereof.

In certain embodiments, the one or more plating metals can include iron triad metals and their alloys. In certain embodiments, the one or more plating metals can include nickel (Ni), cobalt (Co), or iron (Fe).

In certain embodiments, the processing solution can include a blend of one or more salts.

In certain embodiments, the conductivity of the processing solution can be measured at a fixed temperature.

In certain embodiments, the processing solution can be a semiconductor processing solution.

An exemplary method for determining a concentration of a halide ion in a processing solution including a plurality of halide ions and a predetermined concentration of one or more plating metals is provided. The method includes performing a first analytical method comprising measuring a conductivity of the processing solution to provide a first measurement, and determining a concentration the halide ion based on the first measurement and the predetermined concentration of the one or more plating metals. The halide ion is selected from the plurality of halide ions.

In certain embodiments, the plurality of halide ions can include chloride (Cl), bromide (Br), iodide (I), or combinations thereof.

In certain embodiments, the one or more plating metals can include iron triad metals and their alloys. In certain embodiments, the one or more plating metals can include nickel (Ni), cobalt (Co), or iron (Fe).

In certain embodiments, the processing solution can include a blend of one or more salts.

In certain embodiments, the conductivity of the processing solution can be measured at a fixed temperature.

In certain embodiments, the processing solution can be a semiconductor processing solution.

An exemplary apparatus for determining concentrations of a halide ion in a processing solution comprising a plurality of halide ions and one or more plating metals is provided. The apparatus includes a reservoir adapted to contain a test solution comprising the processing solution, and a sampling mechanism coupled to the reservoir and adapted to provide a predetermined volume of the test solution from the reservoir to one or more sensors coupled to the sampling mechanism. Each of the one or more sensors are adapted to receive at least a portion of the predetermined volume of the test solution, and are operative to perform one or more analytical methods. The one or more sensors are selected from the group consisting of a conductivity sensor and an absorbance sensor.

In certain embodiments, the test solution can include one or more samples of the processing solution.

In certain embodiments, the test solution can further include one or more standard solutions.

In certain embodiments, the sampling mechanism can include a syringe, a volumetric flask, a graduated cylinder, an automatic syringe, or a metering pump.

In certain embodiments, the one or more analytical methods can include one or more of measuring a conductivity of the test solution, a concentration of the one or more plating metals, or an absorbance of the test solution.

In certain embodiments, the apparatus can further include an absorbance meter, a light source, an optical detector, or a combination thereof coupled to the absorbance sensor.

In certain embodiments, the apparatus can further include a conductivity meter coupled to the conductivity sensor.

In certain embodiments, the one or more sensors can include the conductivity sensor and the absorbance sensor.

In certain embodiments, the processing solution can include a predetermined concentration of the one or more plating metals, and the one or more sensors can include the conductivity meter.

In certain embodiments, the one or more plating metals can include iron triad metals and their alloys.

In certain embodiments, the one or more plating metals can include nickel (Ni), cobalt (Co), or iron (Fe).

### BRIEF DESCRIPTION OF THE DRAWINGS

FIG. 1 schematically illustrates an exemplary apparatus of the present disclosure for halide analysis of processing solutions;

FIG. 2 illustrates the results of the measured concentration (g/L) of chloride (Cl) versus the expected concentration (g/L) of chloride (Cl) in solution samples in accordance with Example 1; and

FIG. 3 illustrates the results of the measured concentration (g/L) of chloride (Cl) versus the expected concentration (g/L) of chloride (Cl) in solution samples in accordance with Example 2.

### DETAILED DESCRIPTION

The present disclosure provides techniques for selective measurement and monitoring of halide ions (e.g., chloride (Cl), bromide (Br), or iodide (I)) in processing solutions such as semiconductor processing solutions. In certain embodiments, the present disclosure combines a first analytical method with a second analytical method to accurately determine the concentration of predetermined halide ions in a solution. The first analytical method can be conductivity measurements, and the second analytical method can be absorbance measurements. The present disclosure also provides for combining a first analytical method with the plating metal concentration in the processing solution, for example, by having a predetermined concentration of a plating metal (e.g., nickel (Ni)) or a second analytical method, which can be measurement of the same in the processing solution. Accordingly, halide ions present in a processing solution can be selectively determined, measured, and monitored without a reagent.

Technical terms used in the present disclosure are generally known to those skilled in the art. The phrase “predetermined concentration” as used herein refers to a known, target, or optimum concentration of a component in a solution.

As used herein, the term “selective” or “selectively” refers to, for example, the monitoring, measurement or determination of a characteristic of a specific or particular component. For example, the selective measurement of a halide ion refers to the measurement of one particular or predetermined target halide ion from a plurality of halide ions present in solution.

As used herein, the term “accurate” or “accurately” refers to, for example, a measurement or determination that is relatively close to or near an existing or true value, standard, or known measurement or value.

As used herein, the term “about” or “approximately” means within an acceptable error range for the particular value as determined by one of ordinary skill in the art, which will depend in part on how the value is measured or determined, i.e., the limitations of the measurement system. For example, “about” can mean a range of up to 20%, up to 10%, up to 5%, and or up to 1% of a given value.

As used herein, the terms “coupled” or “operatively coupled” refers to one or more components being combined with each other and as used herein is intended to mean either an indirect or a direct connection. Thus, if one device couples to a second device, that connection may be through a direct connection, or through an indirect mechanical or other connection via other devices or connections.

The methods of the present disclosure can be applied to various types of solutions including processing solutions. In certain embodiments, the processing solution can be a semiconductor processing solution.

In certain embodiments, the processing solution can include one or more halide ions. A person skilled in the art will appreciate that a wide variety of halide ions are suitable for use with the present disclosure. In certain embodiments, the one or more halide ions can include chloride (Cl), bromide (Br), iodide (I), or combinations thereof.

In certain embodiments, the processing solution can include one or more plating metals. A person skilled in the art will appreciate a wide combination of plating metals are suitable for use with the present disclosure. In certain embodiments, the one or more plating metals can include iron triad metals and their alloys. Iron triad metals can include nickel (Ni), cobalt (Co), and iron (Fe). In certain embodiments, the one or more plating metals can include nickel (Ni).

Methods of the present disclosure provide multiple analytical methods and measurements of processing solutions, for example, to advantageously selectively measure and monitor halide ions in a processing solution. The concentration of one or more halide ions can be monitored in a processing solution by performing a first analytical method, for example, by measuring a conductivity of the processing solution. In certain aspects, the processing solution can include a blend of one or more salts (e.g., nickel sulfate and nickel chloride or nickel bromide; nickel sulfamate and nickel chloride or nickel bromide; or nickel chloride or nickel bromide and sodium chloride or sodium bromide). A person skilled in the art will appreciate a wide variety of salts are suitable for use with the present disclosure.

In such embodiments, a measurement of conductivity of the processing solution would yield a total concentration of multiple salts. To provide selective measuring and monitoring of halide ions in a processing solution (e.g., chloride (Cl) or bromide (Br)), a second analytical measurement can be conducted. In certain embodiments, the second analytical method can include measuring a plating metal concentration of the processing solution, for example, of one or more iron triad metals and their alloys, such as nickel (Ni). A person skilled in the art will appreciate a wide variety of methods for measuring a plating metal concentration are suitable for use with the present disclosure.

In certain embodiments, the second analytical method can include UV-Vis (ultraviolet-visible spectroscopy). As such, information with respect to halide and plating metal concentrations of a processing solution can be determined by economic, safe, efficient, relatively rapid, and accurate methods. These measurements can be used to selectively determine a concentration of a halide ion in the processing solution. In certain embodiments, a first analytical method, for example, conductivity measurements of the processing solution, can be combined with a second analytical method, for example, metal concentration measurements of the processing solution. In certain aspects, the calculation can be performed with an intermediate process of calculating the metal ion concentration.

For example, in certain embodiments, the halide ion concentration of the processing solution can be determined as follows: [Halide]=A1×[Conductivity]+B1×[Metal]+C1. Coefficients (a), (b), and (c) can be determined by conductivity and spectroscopic measurements of several standard solutions with known concentrations of metal and halide.

In certain embodiments, the concentration of a halide ion in the processing solution can be based on raw analytical signals. For example, the concentration of one or more halides can be monitored in a processing solution by performing a first analytical method, for example, by measuring a conductivity of the processing solution. A second analytical method can also be performed, for example, measuring an absorbance of the processing solution can be performed. These measurements can advantageously be used to selectively determine a concentration of a halide ion in the processing solution.

For example, in certain embodiments, the halide ion concentration of the processing solution can be determined as follows: [Halide]=A2×[Conductivity]+B2×[Absorbance]+C2. Coefficients (a), (b), and (c) can be determined by conductivity and spectroscopic measurements of solutions with known concentrations of metal and halide.

These measurements can be used to selectively determine the concentration of halide ions in the processing solution. In certain embodiments, a first analytical method, such as conductivity measurements of the processing solution, can be combined with a second analytical method, such as metal concentration measurements of the processing solution. Further, in certain embodiments, a first analytical method, such as conductivity measurements of the processing solution, can be combined with a second analytical method, such as absorbance measurements of the processing solution.

In certain embodiments, the conductivity of the processing solution can be measured. For example, in certain embodiments, the conductivity of the processing solution can be measured by a conductivity meter. A person skilled in the art will appreciate a wide variety of methods for measuring conductivity are suitable for use with the present disclosure. In certain embodiments, the conductivity measurement can be performed at a fixed temperature or temperature compensation. In certain embodiments, the conductivity measurement can be standardized to a specific temperature.

In certain embodiments, the absorbance of the processing solution can be measured. A person skilled in the art will appreciate a wide variety of methods for measuring absorbance are suitable for use with the present disclosure.

Methods of the present disclosure provide for selectively determining a concentration of a predetermined halide in a processing solution. In certain embodiments, the method can include providing a processing solution. The processing solution can include a plurality of halides and a plating metal. In certain embodiments, a first analytical method of the processing solution can be performed to provide a first measurement. The first analytical method can include measuring a conductivity of the processing solution. In certain embodiments, the method can include performing a second analytical method on the processing solution to provide a second measurement. The second analytical method can include measuring a concentration of the plating metal. The method can further include determining a concentration of the predetermined halide of the plurality of halides based on the first and second measurements.

Methods of the present disclosure provide for selectively determining a concentration of a predetermined halide in a processing solution. In certain embodiments, the method can include providing a processing solution. The processing solution can include a plurality of halides and a plating metal. In certain embodiments, a first analytical method of the processing solution can be performed to provide a first measurement. The first analytical method can include measuring a conductivity of the processing solution. In certain embodiments, the method can include performing a second analytical method of the processing solution to provide a second measurement. The second analytical method can include measuring an absorbance of the processing solution. The method can further include determining a concentration of the predetermined halide of the plurality of halides based on the first and second measurements.

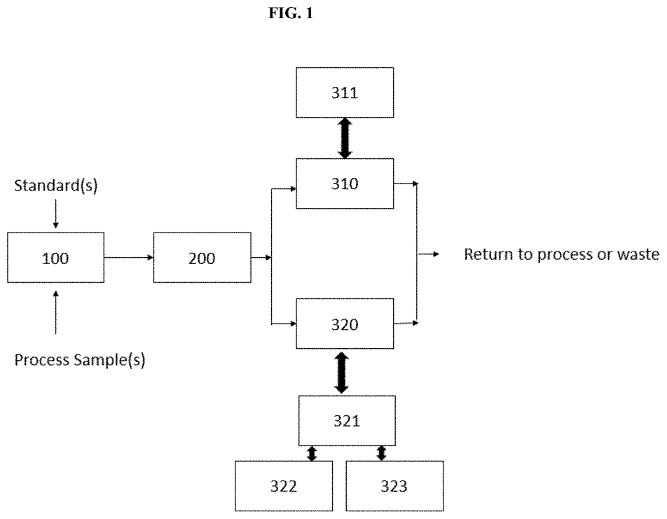

FIG. 1 schematically illustrates an exemplary apparatus of the present disclosure. In certain aspects, the exemplary apparatus can relate to measuring and monitoring halide concentrations in processing solutions, for example, for iron triad metals and their alloys. The apparatus can include one or more sensors, for example, operative to perform one or more analytical methods. In certain embodiments, the one or more sensors can include a conductivity sensor 310, an optical sensor 320 (e.g., an absorbance sensor), or combinations thereof. In certain embodiments, the apparatus can further include a conductivity meter 311, an absorbance meter 321, a light source 322, an optical detector 323, or combinations thereof.

In certain embodiments, the conductivity meter 311 can be connected to the conductivity sensor 310. In certain embodiments, the absorbance meter 321, the light source 322, and/or the optical detector 323 can be connected to the optical sensor 320. In certain embodiments, the light source 322 and/or the optical detector 323 can be connected to the absorbance meter 321. The apparatus can further include a selector device 100, a sample introducer device 200, or combinations thereof. In certain embodiments, the apparatus can further include the selector device 100 and the sample introducer device 200.

In certain embodiments, the selector device 100 can include a solution, for example, one or more standard solutions, one or more process samples, or combinations thereof. The selector device 100 can be coupled to the sample introducer device 200. In certain embodiments, the sample introducer device 200 can provide a predetermined volume of the solution contained in the selector device 100 to the one or more sensors. In certain embodiments, the sample introducer device 200 can provide about 5 mL to about 45 mL, about 5 mL to about 40 mL, about 5 mL to about 35 mL, about 5 mL to about 30 mL, about 5 mL to about 25 mL, about 5 mL to about 20 mL, about 5 mL to about 10 mL, or about 10 mL to about 30 mL of the solution to the one or more sensors. For example, the sampling introducer device can provide about 5 mL, about 10 mL, about 15 mL, about 20 mL, about 25 mL, about 30 mL, about 35 mL, about 40 mL, or about 45 mL of the solution to the one or more sensors. Suitable sample introducer devices 200 for providing the predetermined volume of the solution contained in the selector device 100 can include a syringe, or a graduated cylinder, for example, for manual delivery, or an automatic syringe or a metering pump with associate plumbing and wiring, for example, for automatic delivery. Delivery of the predetermined volume of the solution can also be performed up to a preset level detected by an automatic level sensor. The selector device 100 can be a tank or reservoir. For automatic delivery of the solution, the sample introducer device 200 can be connected, for example, to a pipe running between the selector device 100 and the one or more sensors, for example, the conductivity sensor 310, the optical sensor 320, or combinations thereof.

In certain aspects, a first portion of the predetermined volume of the solution can be delivered to a first sensor, for example, the conductivity sensor 310, and a second portion of the predetermined volume of the solution can be delivered to a second sensor, for example, the optical sensor 320. In certain embodiments, the predetermined volume of the solution can be delivered to the one or more sensors arranged in series in any order, for example, the first sensor and subsequently the second sensor. In certain embodiments, the predetermined portion of the solution can be delivered to the one or more sensors arranged in combination with each other.

The one or more sensors can be operative to perform or more analytical methods. In certain embodiments, the one or more analytical methods can include measuring conductivity (e.g., of the solution), measuring a concentration (e.g., of plating metal in the solution), measuring an absorbance (e.g., of the solution), or combinations thereof. The one or more sensors can include the conductivity sensor 310, the optical sensor 320, or combinations thereof. In certain embodiments, the apparatus can include the conductivity sensor 310 and the optical sensor 320. The conductivity sensor 310 can measure a conductivity, for example, of the solution. The optical sensor 320 can measure an absorbance, for example, of the solution. In certain aspects, the apparatus can include a device or sensor for measuring a concentration, for example, of plating metal in the solution. The one or more sensors can be in parallel, in series in any order, or combined. For example, and not by way of limitation, in certain embodiments, the apparatus can include the conductivity sensor 310 and the optical sensor 320 in parallel, in series in any order, or combined. In certain embodiments, the conductivity sensor 310 and the optical sensor 320 can be in parallel.

In certain embodiments, the apparatus can further include the conductivity meter 311. The conductivity meter 311 can be operatively coupled to the conductivity sensor 310. In certain embodiments, the conductivity meter 311 can be coupled to the conductivity sensor 310 through a cable, for example, an electrical cable. The apparatus can further include the absorbance meter 321, for example, a spectrophotometer. In certain embodiments, the absorbance meter 321 can be operatively coupled to the optical sensor 320. In certain aspects, the apparatus can further include the light source 322, the optical detector 323, or combinations thereof. In certain embodiments, the apparatus can include the light source 322 and the optical detector 323. The light source 322 can be operatively coupled to the absorbance meter 321 and/or the optical sensor 320, for example, by fiber optics. The optical detector 323 can be operatively coupled to the absorbance meter 321 and/or optical sensor 320, for example, by fiber optics.

After analytical measurements of the solution are completed, the solution can be flowed to return to the process or discarded as waste.

### EXAMPLES

The presently disclosed subject matter will be better understood by reference to the following Examples. The following Examples are merely illustrative of the presently disclosed subject matter and they should not be considered as limiting the scope of the subject matter in any way.

### Example 1: Selective Measurement of Halide Ions with Conductivity Measurement and Predetermined Nickel (Ni) Concentrations

This Example provides for selective measurement of halide ions, for example, chloride (Cl), in a processing solution with predetermined concentrations of nickel (Ni) using conductivity measurements and a predetermined concentration of a plating metal. Conductivity was measured for six (6) samples of processing solutions including a plating metal (i.e., nickel (Ni)) and a halide ion (i.e., chloride (Cl) with predetermined nickel (Ni) concentrations. The results of the conductivity measurements of each sample are provided in Table 1 below.

TABLE 1

| | Expected Cl | Expected Ni | Conductivity |
|---|---|---|---|
| Sample | (g/L) | (g/L) | (mS/cm) |
| 1 | 78.0 | 56.16 | 103.7 |
| 2 | 130.0 | 93.6 | 129.9 |
| 3 | 146.3 | 105.3 | 133.3 |
| 4 | 86.9 | 56.16 | 113.2 |
| 5 | 137.4 | 105.3 | 128.1 |
| 6 | 132.6 | 56.16 | 150.1 |

From the conductivity measurements and predetermined concentrations of the plating metal, nickel (Ni), provided in Table 1, the concentration of halide ions, chloride (Cl), in each processing solution sample was selectively determined.

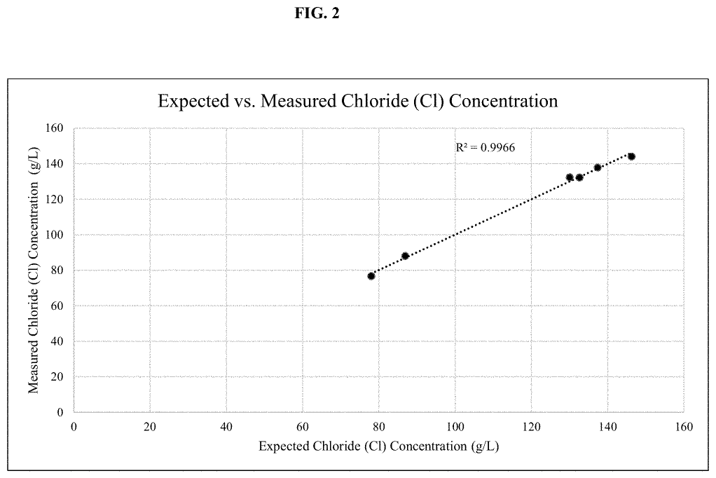

The results are provided in Table 2 and FIG. 2.

TABLE 2

| | Expected Cl | Measured Cl | Accuracy |
|---|---|---|---|
| Sample | (g/L) | (g/L) | (%) |
| 1 | 78 | 76.66 | −1.7 |
| 2 | 130 | 132.34 | 1.8 |
| 3 | 146.25 | 144.01 | −1.5 |
| 4 | 86.89 | 88.03 | 1.3 |
| 5 | 137.36 | 137.79 | 0.3 |
| 6 | 132.59 | 132.21 | −0.3 |
| Average | | | 1.15 |
| Accuracy | | | |

Calculation Parameters

The following calculation parameters (Equation 1 and Table 3) were used to selectively determine the measured concentration of halide ions (i.e., chloride (Cl) in the processing solution.

[Halide]=A1×[Conductivity]+B1×[Metal]+C1 (1)

TABLE 3

| Calculation Parameter | Value |
|---|---|
| A1: g × cm/(1 × mS) | 1.1972 |
| B1 | 0.6495 |
| C1: g/l | 83.965 |

### Example 2: Selective Measurement of Halide Ions with Conductivity and Absorbance Measurements

This Example provides for selective measurement of halide ions, for example, chloride (Cl), in a processing solution using conductivity and absorbance measurements. Conductivity and absorbance were measured for five (5) samples of processing solutions including a plating metal (i.e., nickel (Ni)) and a halide ion (i.e., chloride (Cl)). The expected nickel (Ni) and chloride (Cl) concentrations of each sample are provided in Table 4 below.

TABLE 4

| | Expected Ni | Expected Cl |
|---|---|---|
| Sample | (g/L) | (g/L) |
| 7 | 56 | 78 |
| 8 | 93 | 130 |
| 9 | 105 | 147 |
| 10 | 117 | 162.5 |
| 11 | 56 | 147 |

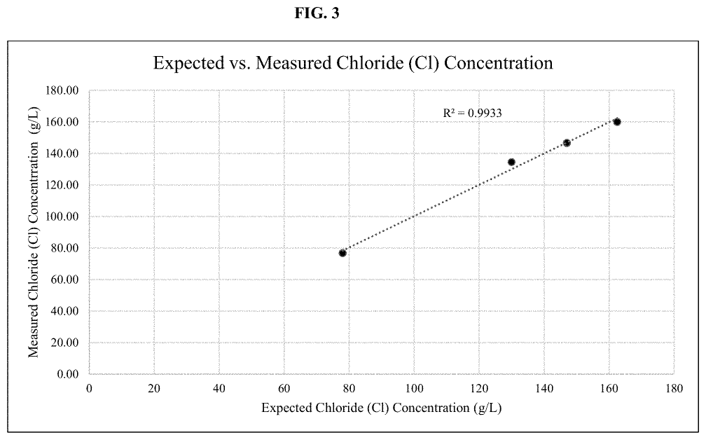

The results of the conductivity and absorbance measurements of each sample are provided in Table 5 below. From the conductivity and absorbance measurements provided in Table 5, the concentration of halide ions, chloride (Cl), in each processing solution sample was selectively determined as shown in Table 5 and FIG. 3.

TABLE 5

| | | Conduc- | Measured | Measured | Cl |
|---|---|---|---|---|---|
| | | tivity | Ni | Cl | Accuracy |
| Sample | Absorbance | (mS/cm) | (g/L) | (g/L) | (%) |
| 7 | 0.396 | 157.5 | 55.41 | 76.70 | −1.7 |
| 8 | 0.713 | 197.3 | 92.15 | 134.49 | 3.5 |
| 9 | 0.810 | 202.1 | 103.39 | 146.46 | −0.4 |
| 10 | 0.942 | 205 | 118.68 | 159.93 | −1.6 |
| 11 | 0.413 | 246 | 57.38 | 146.65 | −0.2 |
| Averaged | | | | | 1.48 |
| Accuracy | | | | | |

Calculation Parameters

The following calculation parameters (Equations 2 and Table 6) were used to selectively determine the measured concentration of the multiple base chemicals in the solution blend.

[Halide]=A2×[Conductivity]+B2×[Absorbance]+C2 (2)

TABLE 6

| Calculation Parameter | Value |
|---|---|
| A2: g × cm/(1 × mS) | 0.774 |
| B2: g/L | 85.1 |
| C2: g/L | −78.9 |

### Example 3: Selective Measurement of Halide Ions (Chloride)—Qualitative Analysis

Methods disclosed herein were assessed by qualitative analysis. A 30-points continuous run and a 3-point run per day for five (5) days was performed. The results for the 30-points continuous run testing are provided in Table 7 below.

TABLE 7
Chloride: 30-points continuous run

| Data Point | Low (g/L) | Target (g/L) | High (g/L) |
|---|---|---|---|
| 1 | 77.21 | 133.04 | 144.13 |
| 2 | 77.11 | 133.08 | 144.43 |
| 3 | 77.24 | 133.10 | 144.17 |
| 4 | 77.13 | 132.95 | 144.40 |
| 5 | 77.22 | 132.94 | 144.46 |
| 6 | 77.49 | 132.99 | 144.35 |
| 7 | 77.32 | 132.92 | 144.31 |
| 8 | 77.27 | 132.82 | 144.42 |
| 9 | 77.39 | 132.90 | 144.44 |
| 10 | 77.38 | 133.06 | 144.37 |
| 11 | 77.36 | 132.93 | 144.45 |
| 12 | 77.52 | 133.16 | 144.36 |
| 13 | 77.51 | 133.15 | 144.51 |
| 14 | 77.50 | 133.16 | 144.68 |
| 15 | 77.53 | 133.04 | 144.47 |
| 16 | 77.56 | 133.20 | 144.32 |
| 17 | 77.47 | 133.29 | 144.40 |
| 18 | 77.52 | 133.46 | 144.50 |
| 19 | 77.57 | 133.21 | 144.33 |
| 20 | 77.47 | 133.26 | 144.44 |
| 21 | 77.58 | 133.25 | 144.47 |
| 22 | 77.55 | 133.35 | 144.57 |
| 23 | 77.72 | 133.29 | 144.38 |
| 24 | 77.62 | 133.18 | 144.68 |
| 25 | 77.72 | 133.05 | 144.53 |
| 26 | 77.62 | 133.34 | 144.42 |
| 27 | 77.71 | 133.11 | 144.29 |
| 28 | 77.69 | 133.14 | 144.29 |
| 29 | 77.73 | 133.15 | 144.18 |
| 30 | 77.47 | 133.31 | 144.21 |
| Average (g/L) | 77.47 | 133.13 | 144.40 |
| Expected (g/L) | 78.00 | 130.00 | 147.00 |
| Accuracy (%) | −0.68 | 2.41 | −1.77 |
| StDev | 0.18 | 0.15 | 0.13 |
| RSD (%) | 0.23 | 0.12 | 0.09 |

The results for the five (5) day with 3-points per day testing is provided in Table 8 below.

TABLE 8
Chloride: 3-points per day for 5-days

| Day | Data Point | Low (g/L) | Target (g/L) | High (g/L) |
|---|---|---|---|---|
| 1 | 1 | 77.74 | 133.15 | 144.51 |
| | 2 | 77.67 | 133.08 | 144.77 |
| | 3 | 77.53 | 132.90 | 144.35 |
| 2 | 1 | 77.97 | 133.47 | 144.82 |
| | 2 | 77.96 | 133.43 | 144.71 |
| | 3 | 77.73 | 133.02 | 144.40 |
| 3 | 1 | 78.06 | 133.74 | 145.12 |
| | 2 | 78.10 | 133.72 | 144.98 |
| | 3 | 78.02 | 133.29 | 144.85 |
| 4 | 1 | 78.18 | 133.81 | 145.01 |
| | 2 | 78.21 | 133.84 | 144.94 |
| | 3 | 78.18 | 133.44 | 144.71 |
| 5 | 1 | 77.89 | 133.38 | 144.79 |
| | 2 | 77.85 | 133.30 | 144.81 |
| | 3 | 77.65 | 133.17 | 144.41 |

| | | | |
|---|---|---|---|
| Average (g/L) | 77.92 | 133.38 | 144.75 |
| Expected (g/L) | 78.00 | 130.00 | 147.00 |
| Accuracy (%) | −0.11 | 2.60 | −1.53 |
| StDev | 0.21 | 0.29 | 0.24 |
| RSD (%) | 0.28 | 0.22 | 0.16 |

The description herein merely illustrates the principles of the disclosed subject matter. Various modifications and alterations to the described embodiments will be apparent to those skilled in the art in view of the teachings herein. Accordingly, the disclosure herein is intended to be illustrative, but not limiting, of the scope of the disclosed subject matter. Moreover, the principles of the disclosed subject matter can be implemented in various configurations and are not intended to be limited in any way to the specific embodiments presented herein.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

What is claimed is:

1. A method for determining a concentration of a halide ion in a processing solution including a plurality of halide ions and one or more plating metals, comprising:
performing a first analytical method comprising measuring a conductivity of the processing solution to provide a first measurement;
performing a second analytical method to provide a second measurement; and
determining a concentration the halide ion based on the first and the second measurements,
wherein the halide ion is selected from the plurality of halide ions, and
wherein the first analytical method is different than the second analytical method.

2. The method of claim 1, wherein the second analytical method comprises measuring a concentration of the one or more plating metals.

3. The method of claim 2, wherein the concentration of the one or more plating metals is measured by UV-Vis (ultraviolet-visible spectroscopy).

4. The method of claim 1, wherein the second analytical method comprises measuring an absorbance of the processing solution.

5. The method of claim 1, wherein the plurality of halide ions comprises chloride (Cl), bromide (Br), iodide (I), or combinations thereof.

6. The method of claim 1, wherein the one or more plating metals comprises iron triad metals and their alloys.

7. The method of claim 6, wherein the one or more plating metals comprises nickel (Ni), cobalt (Co), or iron (Fe).

8. The method of claim 6, wherein the processing solution comprises a blend of one or more salts.

9. The method of claim 1, wherein the conductivity of the processing solution is measured at a fixed temperature.

10. The method of claim 1, wherein the processing solution is a semiconductor processing solution.

11. A method for determining a concentration of a halide ion in a processing solution including a plurality of halide ions and a predetermined concentration of one or more plating metals, comprising:
performing a first analytical method comprising measuring a conductivity of the processing solution to provide a first measurement; and
determining a concentration the halide ion based on the first measurement and the predetermined concentration of the one or more plating metals,
wherein the halide ion is selected from the plurality of halide ions.

12. The method of claim 11, wherein the plurality of halide ions comprises chloride (Cl), bromide (Br), iodide (I), or combinations thereof.

13. The method of claim 11, wherein the one or more plating metals comprises iron triad metals and their alloys.

14. The method of claim 13, wherein the one or more plating metals comprises nickel (Ni), cobalt (Co), or iron (Fe).

15. The method of claim 13, wherein the processing solution comprises a blend of one or more salts.

16. The method of claim 11, wherein the conductivity of the processing solution is measured at a fixed temperature.

17. The method of claim 11, wherein the processing solution is a semiconductor processing solution.

18. An apparatus for determining concentrations of a halide ion in a processing solution comprising a plurality of halide ions and one or more plating metals, comprising:
a reservoir adapted to contain a test solution comprising the processing solution;
a sampling mechanism coupled to the reservoir and adapted to provide a predetermined volume of the test solution from the reservoir to one or more sensors coupled to the sampling mechanism;
wherein each of the one or more sensors are adapted to receive at least a portion of the predetermined volume of the test solution, and are operative to perform one or more analytical methods;
wherein the one or more sensors are selected from the group consisting of a conductivity sensor and an absorbance sensor.

19. The apparatus of claim 18, wherein the test solution comprises one or more samples of the processing solution.

20. The apparatus of claim 18, wherein the test solution further comprises one or more standard solutions.

21. The apparatus of claim 18, wherein the sampling mechanism comprises a syringe, a volumetric flask, a graduated cylinder, an automatic syringe, or a metering pump.

22. The apparatus of claim 18, wherein the one or more analytical methods comprise one or more of measuring a conductivity of the test solution, a concentration of the one or more plating metals, or an absorbance of the test solution.

23. The apparatus of claim 18, further comprising an absorbance meter, a light source, an optical detector, or a combination thereof coupled to the absorbance sensor.

24. The apparatus of claim 18, further comprising a conductivity meter coupled to the conductivity sensor.

25. The apparatus of claim 18, wherein the one or more sensors comprises the conductivity sensor and the absorbance sensor.

26. The apparatus of claim 18, wherein the processing solution comprises a predetermined concentration of the one or more plating metals, and the one or more sensors comprises the conductivity meter.

27. The apparatus of claim 18, wherein the one or more plating metals comprises iron triad metals and their alloys.

28. The apparatus of claim 27, wherein the one or more plating metals comprises nickel (Ni), cobalt (Co), or iron (Fe).
